(19) United States
(12) Patent Application Publication
(10) Pub. No.: US 2009/0063118 A1
(43) Pub. Date: Mar. 5, 2009

(54) Systems and methods for interactive navigation and visualization of medical images

(76) Inventors: Frank Dachille, Wailea, HI (US); George Economos, JR., Bayport, NY (US); Jeffrey Meade, Bay Shore, NY (US); Michael Meissner, Minneapolis, MN (US)

Correspondence Address: F. Chau & Associates, 130 Woodbury Road, Woodbury, NY, 11797, US

(21) Appl. No.: 11/664,942

(22) PCT Filed: Oct. 8, 2005
(86) PCT No.: PCT/US05/36345

§ 371 Date: Nov. 20, 2008

Related U.S. Application Data
(60) Provisional application No. 60/617,559, filed on Oct. 9, 2004.

(51) Int. Cl. G06G 7/60

(52) U.S. Cl. 703/11

(57) ABSTRACT

Systems and methods for visualization and interactive navigation of virtual images of internal organs are provided to assist in medical diagnosis and evaluation of internal organs. In one aspect, an image data processing system (105) includes an image rendering system (111) for rendering multi-dimensional views of an imaged object from an image dataset (106) of the imaged object, a graphical display system (112) for displaying an image of a rendered view according to specified visualization parameters, an interactive navigation system (107) which monitors a user's navigation through a virtual image space of a displayed image and which provides user navigation assistance in the form of tactile feedback by a navigation control unit (115) operated by the user, upon an occurrence of a predetermined navigation event.

### CROSS-REFERENCE TO RELATED APPLICATION

This application claims priority to U.S. Provisional Application No. 60/617,559, filed on Oct. 9, 2004, which is fully incorporated herein by reference.

### TECHNICAL FIELD OF THE INVENTION

The present invention relates generally to systems and methods for aiding in medical diagnosis and evaluation of internal organs (e.g., blood vessels, colon, heart, etc.) More specifically, the invention relates to systems and methods that support visualization and interactive navigation of virtual images of internal organs, and other anatomical components, to assist in medical diagnosis and evaluation of internal organs.

### BACKGROUND

Various systems and methods have been developed to enable two-dimensional (“2D”) visualization of human organs and other components by radiologists and physicians for diagnosis and formulation of treatment strategies. Such systems and methods include, for example, x-ray CT (Computed Tomography), MRI (Magnetic Resonance Imaging), ultrasound, PET (Positron Emission Tomography) and SPECT (Single Photon Emission Computed Tomography).

Radiologists and other specialists have historically been trained to analyze image scan data consisting of two-dimensional slices. Three-Dimensional (3D) images can be derived from a series of 2D views taken from different angles or positions. These views are sometimes referred to as “slices” of the actual three-dimensional volume. Experienced radiologists and similarly trained personnel can often mentally correlate a series of 2D images derived from these data slices to obtain useful 3D information. However, while stacks of such slices may be useful for analysis, they do not provide an efficient or intuitive means to examine and evaluate interior regions of organs as tortuous and complex as a colons or arteries. For example, when imaging blood vessels, 2D cross-sections merely show slices through vessels, making it difficult to diagnose stenosis or other abnormalities. Moreover, with 2D images of colons, it can be difficult to distinguish colonic polyps from residual stool or normal anatomical colonic features such as haustral folds.

In this regard various techniques have been and are continually being developed, to enable 3D rendering and visualization of medical image datasets, wherein the entire volume or portion an imaged organ can be viewed in a 3D virtual space. For instance, 3D virtual endoscopy applications include methods for rendering endoscopic views of hollow organs (such as a colon or blood vessels) and allowing a user to navigate the 3D virtual image space of an imaged colon or blood vessel, for example, by flying through the organ lumen while viewing the inner lumen walls. While navigation and exploration the 3D image space of a virtual organ can provide an efficient or intuitive means to examine and evaluate interior regions of organs, a user can become confused and lose his/her sense of direction and orientation while navigating in virtual space. In this regard, it is desirable to implement methods for assisting user navigation in a complex virtual image space.

### SUMMARY OF THE INVENTION

In general, exemplary embodiments of the invention include systems and methods for visualization and interactive navigation of virtual images of internal organs to assist in medical diagnosis and evaluation of internal organs. In one exemplary embodiment, an image data processing system includes an image rendering system for rendering multi-dimensional views of an imaged object from an image dataset of the imaged object, a graphical display system for displaying an image of a rendered view according to specified visualization parameters, an interactive navigation system which monitors a user's navigation through a virtual image space of a displayed image and which provides user navigation assistance in the form of tactile feedback by a navigation control unit operated by the user, upon an occurrence of a predefined navigation event.

In one exemplary embodiment, force feedback is applied to a steering control unit of the navigation control device to guide the user's flight path in a direction along a predetermined flight path. The predetermined flight path may be a centerline through a lumen of a hollow organ (such as a colon or blood vessel). The predefined event is based on a distance of the virtual camera from the predetermined flight path. The magnitude of the force feedback applied to the steering control unit may vary based on a measure of a distance of the virtual camera from the predetermined flight path.

In another exemplary embodiment of the invention force feedback is applied to a steering control unit of the navigation control device to guide the user's flight path in a direction away from an anatomical object to avoid collision with the object. For virtual endoscopy applications, the anatomical object is a virtual lumen inner wall. The predefined event is based on a distance of the virtual camera to the lumen inner wall. The magnitude of the force feedback applied to the steering control unit can vary based on a measure of the distance of the virtual camera to the anatomical object (e.g., lumen wall). A force feedback may also be applied to a flight speed control unit of the navigation control device to reduce or stop the user's flight path to avoid collision with the anatomical object.

In another exemplary embodiment of the invention, force feedback can be applied to a flight speed control unit of the navigation control device to reduce a flight speed and allow the user to review a region of interest that the user may have missed. For example, the predefined event can be based on a tagged region of interest entering a field of view of a virtual camera A force feedback can be applied to a steering control unit to guide user's flight path in a direction toward the tagged region of interest.

In another exemplary embodiment of the invention, interactive navigation assistance is provided by automatically modulating a user's flight speed upon the occurrence of a triggering event while navigating through a virtual image space such that a perceived flight speed remains substantially constant as the user navigates through the virtual image space. For instance, in virtual endoscopy applications, the triggering event may be based on threshold measures of increasing/decreasing lumen width while navigating along a lumen centerline, or threshold distance measures with regard to the distance between a virtual camera (view point) and a lumen wall. The actual flight speed is gradually reduced or increased as the distance between the virtual camera and lumen wall decreases or increases, respectively, while navigating along a flight path.

In one exemplary embodiment, flight speed is automatically modulated by overriding an input event generated by user operation of a flight speed control unit. In another embodiment, flight speed is automatically modulated by providing force feedback to a flight speed control unit operated by a user to automatically control the flight speed control unit.

These and other exemplary embodiments, aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram of an imaging system according to an embodiment of the invention.

FIG. 2 is a flow diagram illustrating a method for providing interactive navigation according to exemplary embodiments of the invention.

FIG. 3A illustrates an exemplary 3D overview of an imaged colon having a specified flight path through the colon lumen.

FIG. 3B schematically illustrates a method for providing force feedback to control the direction of a user flight path, according to an exemplary embodiment of the invention.

FIG. 4 is a flow diagram illustrating a method for automatically modulating flight speed during user navigation to maintain a constant perceived flight speed, according to an exemplary embodiment of the invention.

FIG. 5 is a flow diagram illustrating a method for fusing and/or overlaying secondary information over a primary 2D/3D view according to an exemplary embodiment of the invention.

FIG. 6 illustrates a method for overlaying secondary information in a primary view according to an exemplary embodiment of the invention.

FIG. 7 is an exemplary filet view of a colon surface according to an exemplary embodiment of the invention.

### DETAILED DESCRIPTION OF EXEMPLARY EMBODIMENTS

Exemplary systems and methods for providing visualization and interactive navigation of virtual images of internal organs, and other anatomical components, will now be discussed in further detail. It is to be understood that the systems and methods described herein may be implemented in various forms of hardware, software, firmware, special purpose processors, or a combination thereof. For example, the methods described herein may be implemented in software as program instructions that are tangibly embodied on one or more program storage devices (e.g., magnetic floppy disk, RAM, CD ROM, DVD ROM, ROM and flash memory), and executable by any device or machine comprising suitable architecture. It is to be further understood that since the constituent system modules and method steps depicted in the accompanying Figures may be implemented in software, the actual connection between the system components (or the flow of the process steps) may differ depending upon the manner in which the present invention is programmed. Given the teachings herein, one of ordinary skill in the related art will be able to contemplate these and similar implementations or configurations of the present invention.

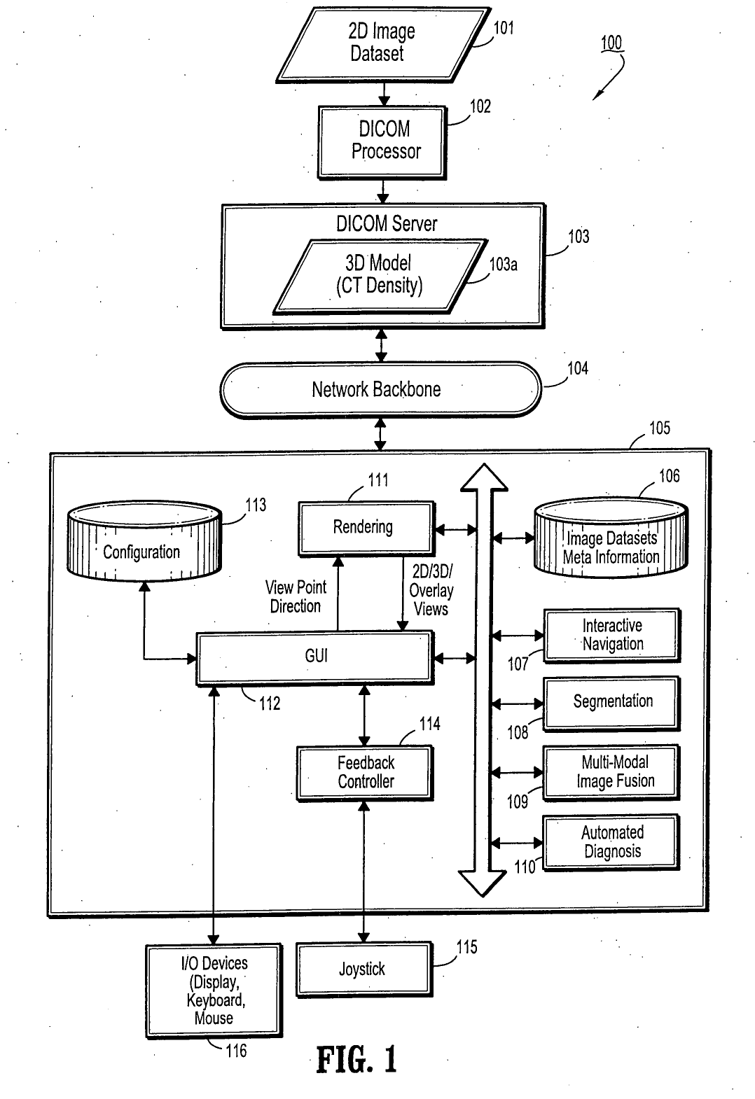

FIG. 1 is a diagram of an imaging system (100) according to an embodiment of the present invention. The imaging system (100) comprises an image acquisition device that generates 2D image datasets (101) which can be formatted in DICOM format by a DICOM processing system (102). For instance, the 2D image dataset (101) may comprise a CT (Computed Tomography) dataset (e.g., Electron-Beam Computed Tomography (EBCT), Multi-Slice Computed Tomography (MSCT), etc.), an MRI (Magnetic Resonance Imaging) dataset, an ultrasound dataset, a PET (Positron Tomography) dataset, an X-ray dataset or a SPECT (Single Photon Emission Computed Tomography) dataset. A DICOM server (103) provides an interface to the DICOM system (102) and receives and process the DICOM-formatted datasets received from the various medical image scanners. The server (103) may comprise software for converting the 2D DICOM-formatted datasets to a volume dataset (103a). The DICOM server (103) can be configured to, e.g., continuously monitor a hospital network (104) and seamlessly accept patient studies automatically into a system database the moment such studies are “pushed” from an imaging device.

The imaging system (100) further comprises an imaging tool (105) that executes on a computer system. The imaging tool (105) comprises a repository (106) for storing image datasets and related meta information, an interactive navigation module (107), a segmentation module (108), a multi-modal image fusion module (109), an automated diagnosis module (110), an image rendering module (111), a user interface module (112), a database of configuration data (113), and a feedback control system (114). A user interacts with the imaging tool (105) using one or more of a plurality of I/O devices including an interactive navigation control device (115) and/or a screen, keyboard, mouse, etc. (116). As explained below, the feedback control system (114) and navigation control device (115) operate to provide one or more forms of tactile feedback to a user when navigating through a virtual image space to provide interactive navigation assistance.

The imaging tool (105) may be a heterogeneous image processing tool that includes methods for processing and rendering image data for various types of anatomical organs, or the imaging tool (105) may implement methods that are specifically designed and optimized for processing and rending image data of a particular organs. The imaging tool (105) can access the DICOM server (103) over the network (104) and obtain 2D/3D DICOM formatted image datasets that are stored in the local repository (106) for further processing.

The user interface module (112) implements methods to process user input events (mouse clicks, keyboard inputs, etc.) for purposes of executing various image processing and rendering functions supported by the imaging tool (105) as well as setting/selecting/changing system parameters (e.g., visualization parameters), which are stored as configuration data in the database (113). The GUI module (112) displays 2D/3D images from 2D/3D views that are rendered by the rendering module (111).

The rendering module (111) implements one or more 2D/3D image rendering methods for generating various types of 2D and 3D views based on user specified and or default visualization parameters. Preferably, the 2D/3D rendering methods support functions such support real-time rendering of opaque/transparent endoluminal and exterior views, rendering of view with superimposed or overlaid images/information, (e.g., superimposed centerlines in colonic endoluminal views, user adjustment of window/level parameters (contrast/brightness), assignment of colors and opacities to image data (based on default or user modified transfer functions which map ranges of intensity or voxel values to different colors and opacities), user interaction with and manipulation of rendered views (e.g., scrolling, taking measurements, panning zooming, etc.). The rendering module (111) generates 2D and 3D views of an image dataset stored in the repository database (106) based on the viewpoint and direction parameters (i.e., current viewing geometry used for 3D rendering) received from the GUI module (112). The repository (106) may include 3D models of original CT volume datasets and/or tagged volumes. A tagged volume is a volumetric dataset comprising a volume of segmentation tags that identify which voxels are assigned to which segmented components, and/or tags corresponding other types of information which can be used to render virtual images. When rendering an image, the rendering module (111) can overlay an original volume dataset with a tagged volume, for example.

The segmentation module (108) implements one or more known automated or semi-automated methods segmenting features or anatomies of interest by reference to known or anticipated image characteristics, such as edges, identifiable structures, boundaries, changes or transitions in colors or intensities, changes or transitions in spectrographic information, etc. The segmentation module (108) comprises methods that enable user interactive segmentation for classifying and labeling medical volumetric data. The segmentation module (108) comprises functions that allow the user to create, visualize and adjust the segmentation of any region within orthogonal, oblique, curved MPR slice image and 3D rendered images. The segmentation module (108) is interoperable with annotation methods to provide various measurements such as width, height, length volume, average, max, std deviation, etc of a segmented region. Various types of segmentation methods that can be implemented are well known to those of ordinary skill in the art, and a detailed discussion thereof is not necessary and beyond the scope of the claimed inventions.

The automated diagnosis module (110) implements methods for processing image data to detect, evaluate and/or diagnose or otherwise classify abnormal anatomical structures such as colonic polyps, aneurisms or lung nodules. Various types of methods that can be implemented for automated diagnosis/classification are well known to those of ordinary skill in the art, and a detailed discussion thereof is not necessary and beyond the scope of the claimed inventions.

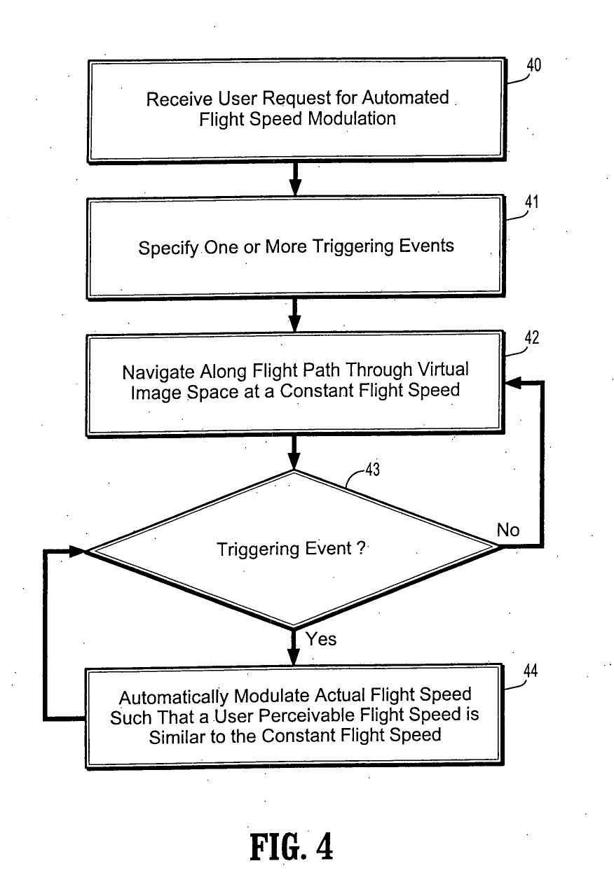

The multi-modal image fusion module (109) implements methods for fusing (registering) image data of a given anatomy that is acquired from two or more imaging modalities. As explained below with reference to FIG. 5-7, the multi-modal image fusion module (109) implements methods for combining different modes of data in a manner that allows the rendering module (111) to generate 2D/3D views using different modes of data to thereby enhance the ability to evaluate imaged objects.

The interactive navigation module (107) implements methods that provide interactive user navigation assistance to a user when navigating through a virtual image space. For example, as explained in further detail below, methods are employed to monitor a user's navigation (flight path and/or flight speed, for example) though a virtual image space (2D or 3D space) and provide some form of tactile feedback to the user (via the navigation control device (115)) upon the occurrence of one or more predefined events. As explained below, tactile feedback is provided for purposes of guiding or otherwise assisting the user's exploration and viewing of the virtual image space.

In accordance with an exemplary embodiment of the invention, navigation through virtual image space is based on a model in which a “virtual camera” travels through s virtual space with a view direction or “lens” pointing in the direction of the current flight path. Various methods have been developed to provide camera control in the context of navigation within a virtual environment. For instance, U.S. patent application Ser. No. 10/496,430, entitled “Registration of Scanning Data Acquired from Different Patient Positions” (which is commonly assigned and fully incorporated herein by reference) describes methods for generating a 3D virtual image of an object such as a human organ using volume visualization techniques, as well as methods for exploring the 3D virtual image space using a guided navigation system. The navigation system allows a user to travel along a predefined or dynamically computed flight path through the virtual image space, and to adjust both the position and viewing angle to a particular portion of interest in the image away from such predefined path in order to view regions of interest (identify polyps, cysts or other abnormal features in an organ). The camera model provides a virtual camera that can be fully operated with six degrees of freedom (3 degrees movement in horizontal, vertical, and depth directions (x,y,z) and 3 degrees of angular rotations) in a virtual environment, to thereby allow the camera to move and scan all sides and angles of a virtual environment.

In accordance with one embodiment of the invention, the navigation control device (115) can be operated by a user to control and manipulate the orientation/direction and flight speed of the “virtual camera”. For instance, in one exemplary embodiment of the invention, the navigation control device (115) can be a handheld device having a joystick that can be manipulated to change the direction/orientation of the virtual camera in the virtual space. More specifically, in one exemplary embodiment, the joystick can provide two-axis (x/y) control, where the pitch of the virtual camera can be assigned to the y-axis (and controlled by moving the joystick in a direction up and down) and where the heading of the virtual camera can be assigned to the x-axis (and controlled by moving the joystick in a direction left and right). The navigation control device (115) may further include an acceleration button or pedal, for instance, that a user can press or otherwise actuate (with varying degrees) to control the velocity or flight speed of the virtual camera along a user-desired flight path directed by user manipulation of the joystick.

When free flying through a 3D space (such as a within a colon), a user can lose a sense of direction and orientation or otherwise navigate at some flight speed along some flight path that causes the user to inadvertently pass some region of interest in the virtual image space the user may have found to be of particular interest for careful examination. In this regard, the navigation control device (115) can be adapted to provide some form of tactile feedback to the user (while operating the control device (115) in response to feedback control signals output from the feedback controller (114). The feedback controller (114) can generate feedback control signals under command from the interactive navigation module (107) upon the occurrence of one or more pre-specified conditions (as described below) for triggering user-assisted navigation. The navigation control device (115) provides appropriate tactile feedback to the user in response to the generated feedback control signals to provide the appropriate user navigation assistance.

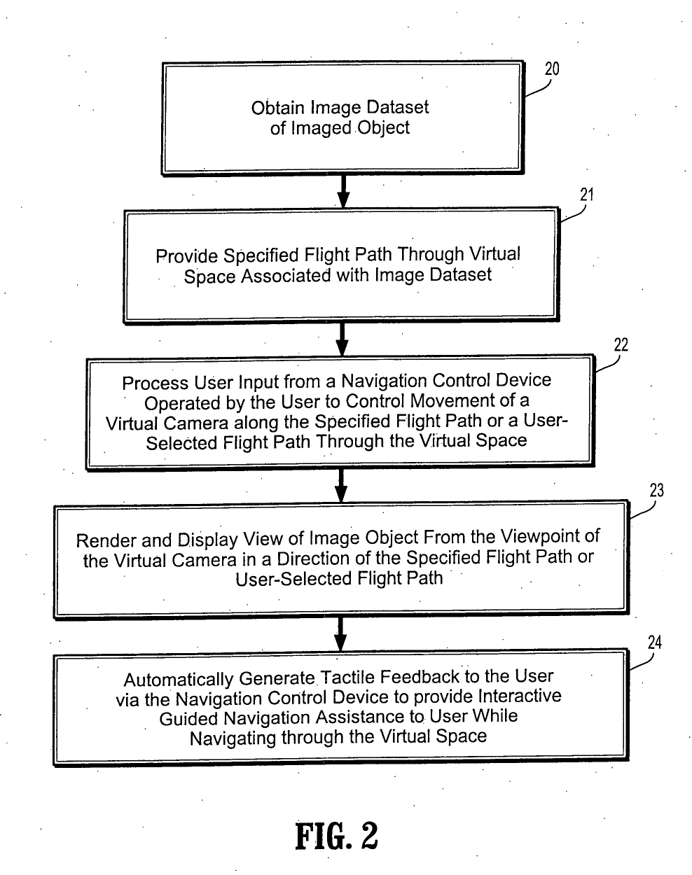

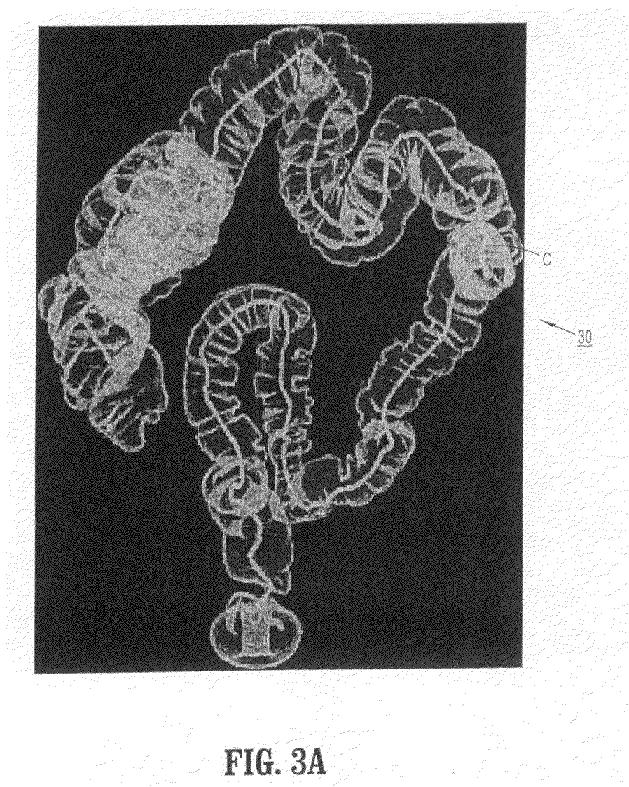

FIG. 2 is a flow diagram illustrating methods for providing interactive navigation according to exemplary embodiments of the invention. As an initial step, the imaging system will obtain and render an image dataset of an imaged object (step 20). For instance, in a virtual colonoscopy application, the image dataset may comprise a 3D volume of CT data of an imaged colon. In one exemplary embodiment of the invention, to support some type(s) of user-assisted navigation, the imaging system will provide a specified flight path through the virtual image space of the image dataset (step 21). In one exemplary embodiment of the invention, a fly-path through a virtual organ, such as a colon lumen, is generated. For instance, FIG. 3A illustrates a 3D overview of an imaged colon (30) having a specified flight path through the colon lumen. In the exemplary embodiment, the specified flight path is a center line C that is computed inside the colon lumen, and such path can be traversed for navigating through the colon at the center of the colon. The centerline C can be computed using known methods such as those disclosed in U.S. Pat. No. 5,971,767 entitled “System and Method for Performing a Three-Dimensional Virtual Examination”, which is incorporated by reference herein in its entirety.

It is to be understood that the use of a pre-specified flight path is optional. As will be explained below, a pre-specified flight path can be implemented to support one or more forms of interactive user navigation assistance. In other exemplary embodiments of the invention, interactive user navigation assistance can be provided without use of a pre-specified flight path.

The system will process user input from a navigation control device that is manipulated by the user to direct the movement and orientation of a virtual camera along a given flight path (step 22). In one exemplary embodiment of the invention, the user can traverse the pre-specified flight path (e.g., colon centerline C) or freely navigate along a user selected flight path that diverges from the pre-specified flight path. In particular, the user can navigate through the virtual space using the pre-specified flight path, whereby the virtual camera automatically travels along the pre-specified flight path with the user being able to control the direction and speed along the pre-specified flight path by manipulating the input control device. In addition, the user can freely navigate through the virtual space away from the pre-specified flight path by manipulating the control device appropriately.

As the user navigates through the virtual space, the system will render and display a view of the imaged object from the view point of the virtual camera in the direction of the given flight path (specified or user-selected path) (step 23). For 3D visualization and navigation, any one of well-known techniques for rendering and displaying images in real-time may be implemented, the details of which are not necessary and outside the scope of this invention. As the user navigates through the virtual space, the system will provide interactive navigation assistance by automatically providing tactile feedback to the user via the input control device upon the occurrence of some predetermined condition/event (step 24). The type of tactile feedback can vary depending on the

For instance, in one exemplary embodiment, the interactive navigation module (107) can track a user's flight path in a 3D virtual image space within an organ lumen (e.g., colon) and provide force feedback to the input control device to guide the user's path along or in proximity to the pre-specified flight path (e.g., centerline of a colon lumen). In this regard, a feedback controller (114) can generate control signals that are applied to the control device (115) to generate the force feedback to the joystick manipulated by the user as a way of guiding the user's free flight in the direction of the pre-specified flight path. By way of example, FIG. 3B schematically illustrates a method for providing force feedback to control the direction of the flight path. FIG. 3B illustrates an exemplary virtual space (colon lumen) having a pre-specified path (e.g., colon centerline C) and a virtual camera at position P and a user selected direction D. The navigation control device (115) can be controlled to apply an appropriate feedback force to the joystick to help guide the user's path in the direction D1 in the vicinity of the pre-specified path C.

In the exemplary embodiment of FIG. 3B, a corrective force that must be applied to the input device to yield the direction D₁ can be computed using any suitable metric. For instance, the magnitude of the applied feedback force can be a function of the current distance between the virtual camera and the pre-specified path, whereby the feedback force increases the further away the virtual camera is from the pre-computed path. On the other hand, when the virtual camera is close to the pre-specified path, a gentle feedback force can be applied to the joystick guide the user along the pre-specified path. This form of tactile feedback enhances the user's ability to freely manipulate a camera in 3D space while staying true to a pre-computed optimal path. The user can override or otherwise disregard such feedback by forcibly manipulating the joystick as desired. The user may release the joystick and allow the force feedback to automatically manipulate the joystick and thus, allow the navigation system to essentially steer the virtual camera in the in the appropriate direction.

In another exemplary embodiment, the interactive navigation module (107) could provide free-flight guided navigation assistance without reference to a pre-specified flight path. For instance, went navigating through a organ lumen, force feedback can be applied to the joystick in a manner similar to that described above when the virtual camera moves to close the lumen wall to steer the virtual camera away from the lumen wall and avoid a collision. In addition, force feedback can be applied to the flight control button pedal to slow down or otherwise stop the movement of the virtual camera to avoid a collision with the lumen wall. The force feedback can be applied to both the joystick and flight speed control pedal as a means to slow the flight speed of the virtual camera and have time to steer away from, and avoid collision with, the lumen wall.

In another exemplary embodiment of the invention, tactile feedback can be in the form of a feedback force applied to the flight speed control unit (e.g., pedal, button, or throttle slider control, etc.) as a means to control the flight speed for other purposes (other than avoiding collision with the lumen wall). For instance, as a user is traveling in virtual space along a given path (user selected or pre-specified path), the system can apply a feedback force to the speed control pedal/button as a means of indicating to the user that the user should slow down or stop to review a particular region of interest. For instance, the image data may include CAD marks or tags (e.g., results from computer automated diction, segmentation, diagnosis, etc.) associated with the image data, which were generated during previous CAD processing to indicate regions of interest that are deemed to have potential abnormalities or actual diagnosed conditions (e.g., polyp on colon wall). However, depending on various factors such as the particular view point in the virtual image space, the user-selected flight path, the flight speed, etc., the user may inadvertently pass or otherwise miss a particular marked or tagged region of interest in the virtual image that requires a careful examination. In this instance, the system can generate control signals to the navigation control device to provide force feedback on the flight speed control button/pedal as a way of indicating to the user or otherwise forcing the user to reduce the flight speed or stop.

It is to be appreciated that other forms of tactile feedback may be implemented to provide interactive navigation assistance, and that the present invention is not limited to force feedback. For instance, the input control device can provide tactile feedback in the form of vibration. In this instance, the vibration can provide an indication to the user that a current region of interest should more carefully reviewed. More specifically, by way of example, while navigation in virtual image space, when the virtual camera approaches a marked or tagged region of interest, the a combination of force feedback and vibration feedback can be applied, whereby the force feedback is applied to the flight speed control button and the control device vibrates, to provide an indication to the user that some potential region of interest is within the current field of view in proximity to the virtual camera. In another embodiment, force feedback can further be applied to the joystick as a means for guiding the user to steer the virtual camera in the direction of the potential region of interest.

It is to be appreciated that the types of tactile feedback and the manner in which the tactile feedback is implemented to for navigation assistance will vary depending on the application and type of control device used. It is to be understood that the above embodiment for tactile feedback are merely exemplary, and that based on the teachings herein, one of ordinary skill in the art can readily envision other forms of tactile feedback (or even visual or auditory feedback) and applications thereof for providing user navigation assistance.

In another exemplary embodiment of the invention, the interactive navigation system implements methods for providing automated flight speech modulation to control flight speed during user navigation through a virtual space. For instance, when performing a diagnostic examination of colon lumen using a 3D endoluminal flight, the examiner must be able to effectively and accurately process the information that is presented during flight. In addition to other factors, the flight speed (or flight velocity) will determine how much and how well information is being presented. As such, flight speed can affect how quickly the user can accurately examine the virtual views. More specifically, while navigating at a constant actual flight speed (as measured in millimeters/second) the flight speed as perceived by the user will vary depending on the distance from the viewpoint to the nearest point on the colon lumen surface.

For example, when navigating through a region of the colon lumen having a gradually decreasing or acute decrease in lumen width (i.e., less insufflation), although the user may be navigating at a constant speed, there will be a gradual increase or abrupt increase in the perceived flight speed by virtue of the viewpoint becoming closer to the colon walls. Moreover, when navigating through a region of the colon lumen having a gradually increasing or acute increase in lumen width (i.e., more insufflation), although the user may be navigating at a constant speed, there will be a gradual decrease or abrupt decrease in the perceived flight speed by virtue of the viewpoint becoming further from the colon walls.

Therefore, as a user is flying through an organ lumen (e.g., colon, blood vessel, etc.), the perceived changes in flight speed through areas of varying lumen width can be very distracting to the user. In particular, when the perceived flight speed increases due to decreased lumen width or when the user's flight path approaches the organ wall, it become more difficult for the user to focus on a particular areas on the lumen wall, because of the perception of increased flight speed. Thus, it is desirable to automatically maintain the perceived flight speed as constant as possible, without the user having to manually control the actual flight speed via the control device.

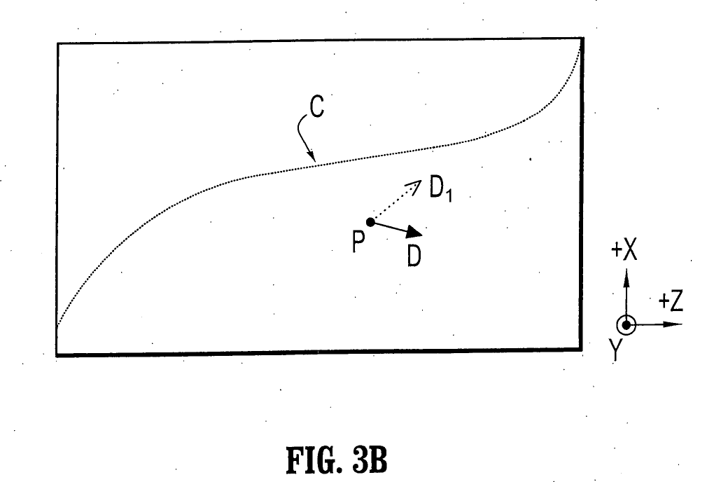

FIG. 4 is a flow diagram illustrating a method for automatically modulating flight speed during user navigation to maintain a constant perceived flight speed. When commencing a navigation session, a user can optionally select a function for flight speed modulation. When the system receives the user request for automated flight speed modulation (step 40), the system will specify one or more predetermined events for triggering flight speed modulation (step 41). As a user is navigating along a flight path through a virtual image space at some constant flight speed (step 42), the system will monitor such navigation session for occurrence of a triggering event (step 43). When a triggering event occurs (affirmative determination in step 43), the system will automatically modulate the actual flight speed such that the user's perceivable flight speed is maintained constant (step 44). For example, the perceivable flight speed is similar to the constant flight speed. In this manner, the user can travel at some desirable constant speed, without be subject to distracting changes in perceived flight speed that can occur under certain circumstances. In one exemplary embodiment, automated flight speed modulation can be employed by overriding the user input generated by the user manipulation of a flight speed control unit. In another exemplary embodiment, automated flight speed modulation can be employed by providing force feedback to the flight speed control unit to control the speed using the actual flight speed control unit. In this manner, the user can override the automated flight speed modulation, for example, by forcibly manipulating the speed control unit despite the feedback force.

The method depicted in FIG. 4 is a high-level description of a method, which can be embodied in various manners depending on the navigation application and type of organ being virtually examined. For illustrative purposes, methods for automated flight speed modulation according to exemplary embodiments of the invention will be described with reference to navigating through an organ lumen and in particular, an endoluminal flight through a colon, but it is to be understood that the scope of the invention is not limited to such exemplary embodiments. In the context of virtual colonoscopy applications, the triggering events can be threshold measures that are based some combination of flight speed and distance of view point to the closest point on the lumen wall or some combination of flight speed and the lumen width, for example.

More specifically, by way of example, for virtual colonoscopy applications where navigation is limited to travel along a specified centerline flight path, for example, the system can specify a range of lumen widths having a lower and upper threshold lumen width, wherein flight speed modulation is performed when a region in the virtual colon lumen has a lumen width outside the threshold range (i.e., the lumen width is less than the lower threshold or greater than the upper threshold). In this instance, a triggering event occurs when the user navigates to a region of the colon within the current field of view having a lumen width that is outside the threshold range. While flying through regions of the colon lumen having widths greater than the upper threshold, the decrease is perceived flight speech may not be too distracting to the user and as such, modulating may not be implemented. However, for lumen widths less than the lower threshold, the increased in perceived flight speed is undesirable, so modulation of the flight speed in such circumstance is desirable. It is to be appreciated that the threshold range of lumen widths can be dynamically varied depending on the user's current flight speed. For instance, at higher flight speeds, the range may be increased, while the range may be decreased for lower flight speeds.

Any suitable metric may be used for modulating the flight speed. In one exemplary embodiment, when traveling to regions of decreased lumen width, the actual flight speed is modulated using some metric based on the lower threshold width. For instance, a neighborhood sample of lumen widths are taken and averaged. The resulting change in velocity can be dynamically computed as some percentage of the averaged lumen width according to some specified metric. This metric is specified to avoid abrupt changes in flight speed due to sharp changes in lumen width (e.g., narrow protruding object). The result is a gradual reduction of the actual flight speed as the user's field of view encounters and passes thru areas of decreased lumen width resulting in little or no perceivable increase in flight speed. In this manner, the user can travel along the centerline of the colon lumen at a constant speed, while being able to examiner regions of smaller lumen width without having to manually reduce the flight speed.

In another exemplary embodiment of the invention, for virtual colonoscopy applications where navigation is not limited to travel along a specified centerline flight path, for example, the system can specify a minimum distance threshold, wherein flight speed modulation is performed when the distance between the viewpoint and a closest point on the lumen wall falls below the minimum distance threshold. In this instance, a triggering event occurs when the user navigates at some constant flight speed and moves the view point close to the lumen wall such that there is a perceived increase in flight speed with respect to proximate regions of the lumen wall. In such instance, modulation of the flight speed is desirable to avoid an increase in the perceived flight speed. It is to be appreciated that the minimum distance threshold range can be dynamically varied depending on the user's current flight speed. For instance, at higher flight speeds, the distance threshold can be increased, while the distance threshold may be decreased for lower flight speeds.

Any suitable metric may be used for modulating the flight speed. In one exemplary embodiment, when navigating close to a lumen wall, the actual flight speed is modulated using some metric based on the minimum distance threshold. For instance, a neighborhood sample of distance measures can be determined and averaged. The resulting change in velocity can be dynamically computed as some percentage of the averaged distance according to some specified metric. This metric is specified to avoid abrupt changes in flight speed when the measure distance to the closest point on the lumen wall is the result of some narrow or sharp protrusion or small object on the wall. The result is a gradual reduction of the actual flight speed as the user's field of view encounters and passes thru areas of decreased lumen width resulting in little or no perceivable increase in flight speed. In this manner, the user can freely navigate along a desired path through the colon at a constant speed, while being able to closely examine regions of the colon wall without having to manually reduce the flight speed.

In another exemplary embodiment of the invention, as noted above, automated flight speed modulation can be implemented in a manner such that a force feedback is applied to the flight speed control unit to reduce or increase the flight speed by automated operation of the flight speed control unit. The magnitude of the applied force can be correlated to the amount of increase or decrease in the actual flight speed needed to maintain a constant perceived speed. Again, the user can override the feedback by forcible manipulating the speed control unit as desired.

In other exemplary embodiments of the invention, automated flight speed modulation can be implemented And proximity to CAD findings and proximity to features previously discovered by the same or other users and proximity to portions of the environment that were not previously exampled fully (what we call missed regions), for example. Other possibilities include pointing the view direction toward features of interest (CAD findings, bookmarks of other users) or in the direction of missed regions.

In other exemplary embodiments of the invention, other types of triggering events can be defined that initiate other types of automated interactive navigation assistance functions. For instance, during a user's navigation in a virtual image space (e.g., 3D endoluminal flight) the field of view (FOV), which is typically given in degrees from left to right and top to bottom of image, can be automatically and temporarily increased to aid the user in visualizing regions of the virtual image space that would otherwise have remained unseen. The FOV can be automatically increased, for instance, while the user is navigating along a path where an unseen marked/tagged region of interest is in close proximity such that increasing the FOV would reveal such region. Further, during a user's navigation in a virtual image space (e.g., 3D endoluminal flight) the view direction (along the flight path) can be automatically and temporarily modified by overriding the user-specified flight path to aid the user in visualizing regions of the virtual image space that would that would otherwise have remained unseen. For example, the system can automatically steer the virtual camera in a direction of an unseen marked/tagged region of interest to reveal such region to the user. These functions can be combined where the system automatically stops the flight, steers the viewpoint in the appropriate direction and enlarges the FOV, to thereby present some region of interest to the user, which the user may have missed or passed by wile free-flight navigating.

These automated functions can be triggered upon the occurrence of certain events, such as based on some distance measure and proximity of the user's current viewpoint to tagged regions in the virtual space (e.g., automatically tagged regions based on CAD results (segmentation, detection, diagnosis, etc.) and/or regions in the virtual image space that were manually tagged/marked by one or more previous users during navigation), or unmarked regions that deemed to have been missed or unexplored, etc.

These functions may or may not be implemented in conjunction with some form of feedback (tactile, auditory, visual). When a user's free flight navigation is temporarily overridden and automatically modified by the system, some form of feedback would be useful to provide some indication to the user of the event. In fact, the tactile feedback navigation assistance embodiments described above with reference to FIG. 2, for example, can be automated functions that are provided without tactile feedback, by simply overriding the user's navigation and automatically temporarily controlling the flight speed and flight to provide navigation assistance.

In another exemplary embodiment of the invention, user navigation and examination of a virtual image is supported by implementing methods for rendering images that incorporate multi-modal data. For instance, FIG. 5 is a high-level flow diagram illustrating a method for fusing and/or overlaying secondary information over a primary 2D/3D view. In one exemplary embodiment, FIG. 5 illustrates an exemplary mode of operation if the multi-modal image fusion module (109) of FIG. 1. An initial step includes generating a primary view of an imaged object using image data having a first imaging modality (step 50). For instance, in one exemplary embodiment, the image data may be CT data associated with an imaged heart, colon, etc. The primary view may be any known view format including, e.g., a filet view (as described below), an overview, an endoluminal view, 2D multi-planar reformatted (MPR) view (either in an axis orthogonal to the original image plane or in any axis), a curved MPR view (where all the scan lines are parallel to an arbitrary line and cut through a 3D curve), a double-oblique MPR view, or 3D views using any projection scheme such as perspective, orthogonal, maximum intensity projection (MIP), minimum intensity projection, integral (summation), or any other non-standard 2D or 3D projection.

A next step includes obtaining secondary data associated with image data that is used for generating the primary view (step 51). The secondary data is combined with associated image data in one or more regions of the primary view (52). An image of the primary view is displayed such that those regions of the primary view having the combined secondary information are visibly differentiated from other regions of the primary view (step 53).

In one exemplary embodiment, the secondary data includes another image data set of the image object which is acquired using a second imaging modality, different from the first imaging modality. For instance, an image data for a given organ under consideration can be acquired using multiple modalities (e.g., CT, MRI, PET, ultrasound, etc.) and virtual images of the organ can be rendered using image data from two or more image modalities in a manner that enhances the diagnostic value. In this exemplary embodiment, the anatomical image data from different modalities are first processed using a fusion process (or registration process) which aligns or otherwise matches corresponding image data and features in the different modality image datasets. This process can be performed using any suitable registration method known in the art.

Once the image datasets are fused, a primary view can be rendered using image data from a first modality and then one or more desired regions of the primary view can be overlaid with image data from a second modality using one or more blending methods according to exemplary embodiments of the invention. For instance, in one exemplary embodiment, the overlay of information can be derived by selective blending the secondary information with the primary information using a blending metric, e.g., a metric based on a weighted average of the two color images of the different modalities. I another embodiment, the secondary data can be overlaid on the primary view by a selective (data sensitive) combination of the images (e.g., the overlaid image is displayed with color and opacity).

It is to be appreciated that overlaying information from a second image modality on a primary image modality can help identify and distinguish abnormal and normal anatomical structures (e.g., polyps, stool, and folds in a colon image). For instance, Positron Emission Tomography (PET) scanners register the amount of chemical uptake of radioactive tracers that are injected into the patient. These tracers move to the sites of increased metabolic activity and regions of the PET image in which such tracers are extremely concentrated as identified as potential cancer sites. Although the information from a PET scan is not very detailed (it has a relatively low spatial resolution compared to CT), PET data can be extremely helpful when overlaid or embedded over CT or other data using techniques described above. The advantage of the overlay of secondary information is that confirmation of suspicious findings is automatic because the information is available directly at the position of suspicion. Furthermore, if suspicious regions are offered by the secondary information (as in PET or CAD), then the viewer is drawn to the suspicious regions by their heightened visibility.

In another exemplary embodiment of the invention, the secondary data can be data that is derived (computed from) either the primary modality image dataset and overplayed on the primary view. In this embodiment, an alignment (registration) process is not necessary when the secondary data is computed or derived from the primary image data. For instance, for virtual colonoscopy applications, when viewing the colon wall, a region of the wall can be rendered using a translucent display to display the volume rendered CT data underneath the normal colon surface, to provide further context for evaluation.

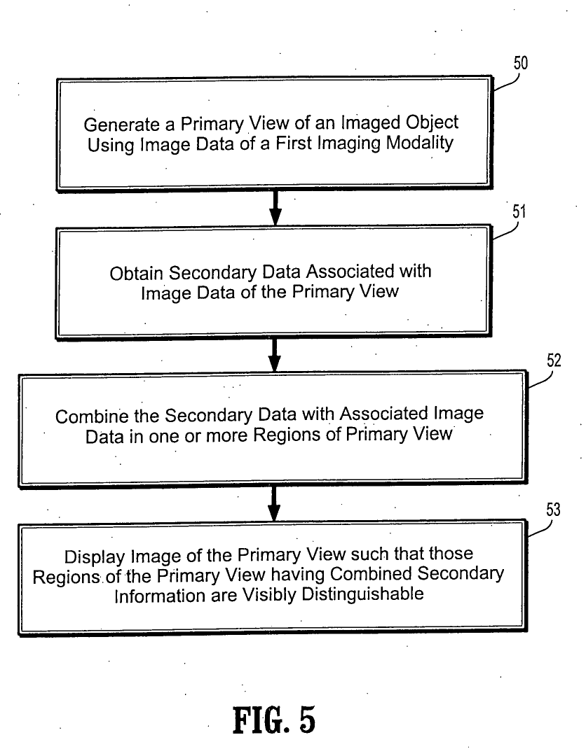

For instance, FIG. 6 is an exemplary view of a portion of a colon inner wall (60), wherein a primary view (61) is rendered having an overlay region (62) providing a translucent view of the CT image data below the colon wall within the region (62). In one exemplary embodiment, the translucent display (62) can be generated by applying a brightly colored color map with a low, constant opacity to the CT data and then volume rendering the CT data from the same viewpoint and direction as the primary image (61).

In another exemplary embodiment, a translucent region (62) can be expanded to use the values of a second modality (e.g., PET) instead of just the CT data. This is helpful because the PET data can be mis-registered by several mm and be hidden under the normal surface. This same technique can be used to overlay PET, SPECT, CAD, shape, other modality data, or derived data onto the normal image. So, instead of viewing the CT data underneath the colon surface, one could view the secondary image data rendered below the colon surface, in effect providing a window to peer into the second modality through the first modality.

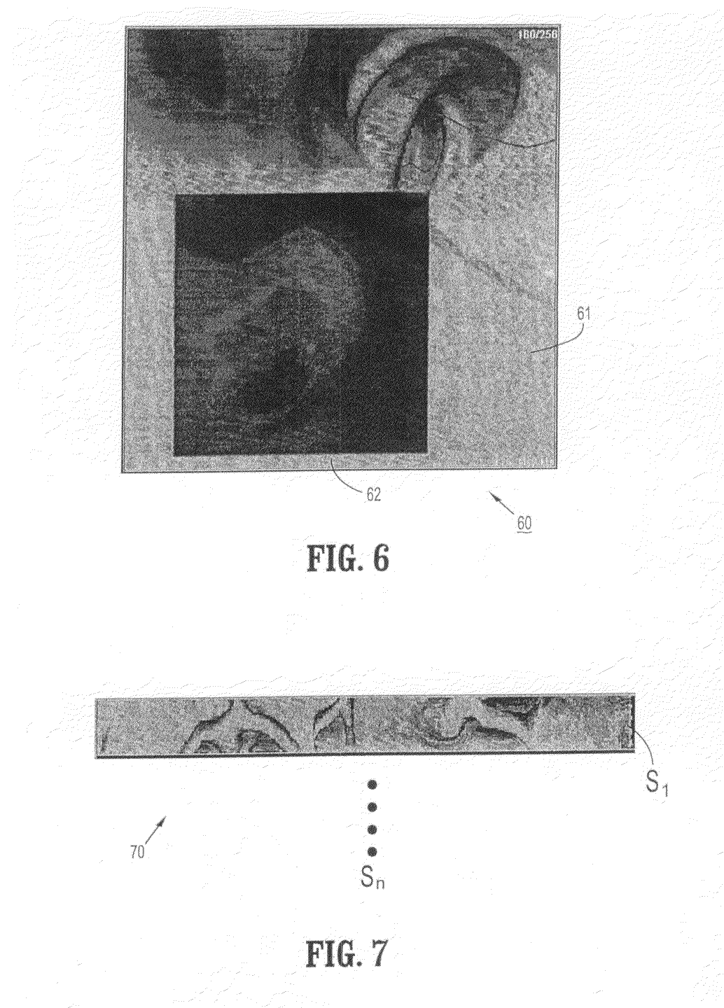

In another exemplary embodiment of the invention, secondary information may be derived data or tertiary information obtained from the results of automated segmentation, detection, diagnosis methods used to process the image information. This secondary information can be overlaid on a primary image to add context for user evaluation. FIG. 7 is an exemplary image of a colon wall displayed as a “filet” view (70) according to an exemplary embodiment of the invention. The exemplary filet view (70) is comprises a plurality of elongated strips (S1˜Sn) of similar width and length, wherein each strip depicts a different region of a colon wall about a colon centerline for a given length of the imaged colon. The filet view (70) is a projection of the colon that stretches out the colon based on a colon centerline and is generated using a cylindrical projection about the centerline. With this view, the portions of the colon that are curved are depicted as being straight such that the filet view (70) introduces significant distortion at areas of high curvature. However, an advantage of the filet view (70) is that a significantly large portion of the colon surface can be viewed in a single image. Some polyps may be behind folds or stretched out to look like folds, while some folds may be squeezed to look like polyps.

The filet view (70) can be overlaid with secondary information. For instance, shape information such as curvature derived about the colon surface, and such shape information can be processed to pseudo color the surface to distinguish various features. In the static filet view (70), it can be difficult to tell the difference between a depressed diverticula and an elevated polyp. To help differentiate polyps versus diverticula in the filet view (70) or other 2D/3D projection view, methods can be applied to pseudo color depressed and elevated regions differently. In particular, in one exemplary embodiment, the shape of the colon surface can be computed and it can be determined at each such region to either color or highlight elevated regions and to color or de-enhance depressed regions.

In another exemplary embodiment, the image data can be processed using automated diagnosis to detect potential polyps. The results of such automated diagnosis can be overlaid on the filet view of the image surface (or other views) to highlight potential polyp locations.

In other embodiment, highlighted PET data could be overlaid on top of the filet view (70) to indicated probable cancers. This overlay can be blended in and out with variable transparency. Data from modalities other than PET, such as SPECT or MRI, can also be overlaid and variable blended with the data, or laid out next to the CT data in alternating rows, for example.

Although exemplary embodiments have been described herein with reference to the accompanying drawings, it is to be understood that the invention described herein is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for providing interactive navigation in a virtual image space, comprising:
moving a virtual camera along a flight path in a virtual image space in response to user manipulation of a navigation control device;
providing navigation assistance to the user by using the navigation control device to provide tactile feedback to the user upon the occurrence of a predefined event.

2. The method of claim 1, wherein providing navigation assistance user comprises providing force feedback to a steering control unit of the navigation control device to guide the user's flight path in a direction along a predetermined flight path.

3. The method of claim 2, wherein the predetermined flight path is a centerline through a lumen of a hollow organ.

4. The method of claim 2, wherein the predefined event is based on a distance of the virtual camera from the predetermined flight path.

5. The method of claim 4, further comprising varying a magnitude of the force feedback applied to the steering control unit based on a measure of a distance of the virtual camera from the predetermined flight path.

6. The method of claim 1, wherein providing navigation assistance user comprises providing force feedback to a steering control unit of the navigation control device to guide the user's flight path in a direction away from an anatomical object to avoid collision with the object.

7. The method of claim 6, wherein the anatomical object is a virtual lumen inner wall.

8. The method of claim 6, wherein the predefined event is based on a distance of the virtual camera to the anatomical object.

9. The method of claim 8, further comprising varying a magnitude of the force feedback applied to the steering control unit based on a measure of the distance of the virtual camera to the anatomical object.

10. The method of claim 6, further comprising providing force feedback to flight speed control unit of the navigation control device to reduce or stop the user's flight path to avoid collision with the anatomical object.

11. The method of claim 1, wherein providing navigation assistance comprises providing force feedback to a flight speed control unit of the navigation control device to reduce a flight speed.

12. The method of claim 11, wherein the predefined event is based on a distance of the virtual camera to an anatomical object in the virtual image space.

13. The method of claim 11, wherein the predefined event is based on a tagged region of interest entering a field of view of the virtual camera.

14. The method of claim 13, further comprising applying force feedback to a steering control unit to guide user's flight path in a direction toward the tagged region of interest.

15. The method of claim 13, further comprising providing a second form of tactile feedback to indicate the presence of the tagged region of interest within the field of view.

16. A method for providing interactive navigation in a virtual image space, comprising:
moving a virtual camera along a flight path at an actual flight speed in a virtual image space in response to user manipulation of a navigation control device;
automatically modulating the actual flight speed upon the occurrence of a triggering event such that a perceived flight remains substantially constant.

17. The method of claim 16, wherein automatically modulating the actual flight speed is performed such that a perceived flight remains substantially similar to the actual flight speed before modulation.

18. The method of claim 16, comprising:
monitoring a position of the virtual camera in the virtual image space; and
determining an occurrence of a triggering event when the flight path of the virtual camera becomes too close to an anatomical object in the virtual image space.

19. The method of claim 18, wherein the virtual image space includes an organ lumen and wherein the anatomical object comprises an inner lumen surface.

20. The method of claim 16, comprising:
monitoring a lumen width in a field of view of the virtual camera as the virtual camera travels along a centerline path through a lumen of an virtual organ; and
determining an occurrence of a triggering event when the lumen width is determined to fall outside a threshold range of lumen widths.

21. The method of claim 20, wherein automatically modulating the actual flight speed comprises gradually decreasing the flight speed as the lumen width decreases.

22. The method of claim 20, wherein automatically modulating the actual flight speed comprises gradually increasing the flight speed as the lumen width increases.

23. The method of claim 16, wherein the triggering event is based, in part, on a current actual flight speed.

24. The method of claim 16, wherein automatically modulating the actual flight speed comprises overriding an input event generated by user operation of a flight speed control unit.

25. The method of claim 16, wherein automatically modulating the actual flight speed comprises providing force feedback to a flight speed control unit operated by a user to automatically control the flight speed control unit.

26. A method for providing interactive navigation in a virtual image space, comprising:
moving a virtual camera along a flight path at a flight speed in a virtual image space in response to user manipulation of a navigation control device;
automatically overriding user control of the virtual camera and automatically controlling the flight path and flight speed upon the occurrence of a triggering event.

26. The method of claim 26, further comprising automatically increasing a field of view (FOV) to aid the user in visualizing a region of interest in the virtual image space.

27. The method of claim 26, comprising automatically modifying a view direction to aid the user in visualizing a region of interest in the virtual space.

28. An image data processing system, comprising:
an image rendering system for rendering multi-dimensional views of an imaged object from an image dataset of the imaged object;
a graphical display system for displaying an image of a rendered view according to specified visualization parameters; and
an interactive navigation system which monitors a user's navigation through a virtual image space of a displayed image and which provides user navigation assistance in the form of tactile feedback by a navigation control unit operated by the user, upon an occurrence of a predetermined navigation event.
